(19) United States
(12) Patent Application Publication
(10) Pub. No.: US 2020/0282489 A1
(43) Pub. Date: Sep. 10, 2020

(54) HEAT TRANSFER PLATE MANUFACTURING METHOD AND FRICTION STIR WELDING METHOD

(71) Applicant: NIPPON LIGHT METAL COMPANY, LTD., Tokyo (JP)

(72) Inventors: Hisashi HORI, Shizuoka (JP); Nobushiro SEO, Shizuoka (JP); Kosuke YAMANAKA, Shizuoka-shi, Shizuoka (JP)

(73) Assignee: NIPPON LIGHT METAL COMPANY, LTD., Tokyo (JP)

(21) Appl. No.: 16/646,067

(22) PCT Filed: May 15, 2018
(86) PCT No.: PCT/JP2018/018694

§ 371 Date: Mar. 10, 2020

(30) Foreign Application Priority Data
Apr. 20, 2018 (JP) 2018-081355

(51) Int. Cl. B23K 20/12

(52) U.S. Cl. CPC B23K 20/122

(57) ABSTRACT

A heat transfer plate manufacturing method in which a tip end-side pin of a rotation tool, as rotating, is inserted into a butt part, and friction stirring is performed with an outer peripheral surface of a base end-side pin in contact with a front surfaces of a base member and a lid plate, with the base end-side pin and a flat surface in contact with the base member and the lid plate, and with a tip end surface of a protrusion part in contact with only the base member, is provided.

### TECHNICAL FIELD

The present invention relates to a heat transfer plate manufacturing method and a friction stir welding method.

### BACKGROUND ART

Among rotation tools to be used for friction stir welding, there is known one which includes a shoulder part and a stirring pin extending vertically downward from the shoulder part. The rotation tool is designed to perform friction stir welding with a lower end surface of the shoulder part pushed in a metal member. The pushing of the shoulder part into the metal member makes it possible to inhibit the occurrence of burr by pressing plastic fluidized material. The rotation tool, however, has a problem that a change in the height position of the joint makes defects likely to occur, enlarges a step recessed groove, and produces much burr.

On the other hand, there is known a friction stir welding method for joining two metal members by use of a rotation tool including a stirring pin, which is characterized in that the friction stir welding method includes a main joining step of: inserting the stirring pin, as rotating, into a butt part between the metal members; and performing friction stir welding on the butt part with only the stirring pin in contact with the metal members (Patent Literature 1). According to this conventional technique, a spiral groove is made in an outer peripheral surface of the stirring pin, and the friction stir welding is performed with only the stirring pin in contact with a joined member, and with abase end part exposed to the outside. Thus, this conventional technique is capable of: inhibiting the occurrence of defects despite a change in the height position of the joint; and reducing load on the friction stirring apparatus. Because, however, plastic fluidized material is not pressed by the shoulder part, the technique has a problem of: enlarging a step recessed groove on the front surface of the metal member; and increasing roughness of the front surface of the joint. The technique has another problem of forming a bulge part (a part where the front surfaces of the metal member stick out more than before the joining) beside the step recessed groove.

Meanwhile, Patent Literature 2 discloses a rotation tool which includes: a shoulder part; and a stirring pin extending vertically downward from the shoulder part. A tapered surface is formed on an outer peripheral surface of each of the shoulder part and the stirring pin. A groove shaped like a spiral in its plan view is formed in the tapered surface of the shoulder part. The cross-sectional shape of the groove is semicircular. Since the tapered surfaces are respectively provided to the shoulder part and the stirring pin, the joining can be stably performed despite changes in the thickness of the metal members and in the height position of the joint. Furthermore, the movement of the plastic fluidized material into the groove makes it possible to control the flow of the plastic fluidized material, and accordingly to form a preferable plasticized region.

### CITATION LIST

### Patent Literature

Patent Literature 1: Japanese Unexamined Patent Publication No. 2013-39613A

Patent Literature 2: Japanese Patent No. 4210148B

### SUMMARY OF INVENTION

### Technical Problem

The conventional art described in Patent Literature 2, however, has a problem that the plastic fluidized material is allowed to come into the groove in the tapered surface and accordingly makes the groove cease its function. The conventional art has another problem that after the plastic fluidized material comes into the groove, the friction stirring is performed with the plastic fluidized material adhering to the groove, and rubbing between the joined metal member and the adhering substance makes the joining quality worse. The conventional art has yet another problem of roughening the front surface of the joined metal member, producing more burrs, and enlarging the step recessed groove on the front surface of the metal member. Meanwhile, there is a demand for friction stir welding which will enhance the joining strength.

From the above viewpoint, the object of the present invention is to provide a heat transfer plate manufacturing method and a friction stir welding method which are capable of: making the step recessed groove on the front surface of the metal member smaller; reducing the roughness of the front surface of the joint; and enhancing the joining strength.

### Solution to Problem

To solve the above problems, a heat transfer plate manufacturing method according to the present invention includes: a lid plate inserting step of inserting a lid plate into a lid groove which is formed around a recessed groove opening at a front surface of a base member; and a main joining step of performing friction stirring by moving a rotation tool including a base end-side pin and a tip end-side pin along and relative to a butt part between a lateral wall of the lid groove and a lateral surface of the lid plate, in which a taper angle of the base end-side pin is greater than that of the tip end-side pin, a stair-shaped step part is formed on an outer peripheral surface of the base end-side pin, a flat surface perpendicular to a rotational axis of the rotation tool, and a protrusion part projecting from the flat surface are formed on a tip-end side of the tip end-side pin, and in the main joining step, the tip end-side pin of the rotation tool, as rotating, is inserted into the butt part, and friction stirring is performed with the outer peripheral surface of the base end-side pin in contact with the front surfaces of the base member and the lid plate, with the base end-side pin and the flat surface in contact with the base member and the lid plate, and with a tip end surface of the protrusion part in contact with only the base member.

A heat transfer plate manufacturing method according to the present invention includes: a heat medium tube inserting step of inserting a heat medium tube into a recessed groove formed in a bottom surface of a lid groove opening at a front surface of a base member; a lid plate inserting step of inserting a lid plate into the lid groove; and a main joining step of performing friction stirring by moving a rotation tool including a base end-side pin and a tip end-side pin along and relative to a butt part between a lateral wall of the lid groove and a lateral surface of the lid plate, in which a taper angle of the base end-side pin is greater than that of the tip end-side pin, a stair-shaped step part is formed on an outer peripheral surface of the base end-side pin, a flat surface perpendicular to a rotational axis of the rotation tool, and a protrusion part projecting from the flat surface are formed on a tip-end side of the tip end-side pin, and in the main joining step, the tip end-side pin of the rotation tool, as rotating, is inserted into the butt part, and friction stirring is performed with the outer peripheral surface of the base end-side pin in contact with the front surfaces of the base member and the lid plate, with the base end-side pin and the flat surface in contact with the base member and the lid plate, and with a tip end surface of the protrusion part in contact with only the base member.

A heat transfer plate manufacturing method according to the present invention includes: a closing step of overlapping a lid plate on a front surface of a base member such that the lid plate covers a recessed groove or a recessed part opening at the front surface of the base member; and a main joining step of inserting a rotation tool including a base end-side pin and a tip end-side pin from a front surface of the lid plate, and moving the rotation tool along and relative to an overlapped part formed by overlapping the front surface of the base member and a back surface of the lid plate, in which a taper angle of the base end-side pin is greater than that of the tip end-side pin, a stair-shaped step part is formed on an outer peripheral surface of the base end-side pin, a flat surface perpendicular to a rotational axis of the rotation tool, and a protrusion part projecting from the flat surface are formed on a tip-end side of the tip end-side pin, and in the main joining step, friction stirring is performed on the overlapped part with the outer peripheral surface of the base end-side pin in contact with the front surface of the lid plate, with the base end-side pin and the flat surface in contact with only the lid plate, and with a tip end surface of the protrusion part in contact with only the base member.

A heat transfer plate manufacturing method according to the present invention includes: a closing step of overlapping a lid plate on a front surface of a base member such that the lid plate covers a recessed groove or a recessed part opening at the front surface of the base member; and main joining step of inserting a rotation tool including a base end-side pin and a tip end-side pin from a back surface of the base member, and moving the rotation tool along and relative to an overlapped part formed by overlapping the front surface of the base member and a back surface of the lid plate, in which a taper angle of the base end-side pin is greater than that of the tip end-side pin, a stair-shaped step part is formed on an outer peripheral surface of the base end-side pin, a flat surface perpendicular to a rotational axis of the rotation tool, and a protrusion part projecting from the flat surface are formed on a tip-end side of the tip end-side pin, and in the main joining step, friction stirring is performed on the overlapped part with the outer peripheral surface of the base end-side pin in contact with the back surface of the base member, with the base end-side pin and the flat surface in contact with only the base member, and with a tip end surface of the protrusion part in contact with only the lid plate.

A friction stir welding method according to the present invention is a friction stir welding method for welding two metal members together using a rotation tool including a base end-side pin and a tip end-side pin, in which a taper angle of the base end-side pin is greater than that of the tip end-side pin, a stair-shaped step part is formed on an outer peripheral surface of the base end-side pin, a flat surface perpendicular to a rotational axis of the rotation tool, and a protrusion part projecting from the flat surface are formed on a tip-end side of the tip end-side pin. The friction stir welding method includes an overlapped part forming step of forming an overlapped part by overlapping a front surface of one metal member and a back surface of the other metal member, and amain joining step of inserting the tip end-side pin of the rotation tool, as rotating, from a front surface of the other metal member, and performing friction stirring on the overlapped part with the outer peripheral surface of the base end-side pin in contact with the front surface of the other metal member, with the base end-side pin and the flat surface in contact with only the other metal member, and with a tip end surface of the protrusion part in contact with only the one metal member. Hardness of the other metal member is set lower than that of the one metal member.

Such methods can achieve the followings. Since the base member, the lid plate or the metal member can be pressed by the outer peripheral surface of the base end-side pin having the large taper angle, the step recessed groove on the front surface of the joint can be made smaller, and concurrently the bulge portion formed beside the step recessed groove can be eliminated or made smaller. Since the stair-shaped step part is shallow and the exit is wide, the plastic fluidized material is less likely to adhere to the outer peripheral surface of the base end-side pin although the metal member is pressed by the base end-side pin. Thereby, the roughness of the front surface of the joint can be reduced, and concurrently the joining quality can be preferably stabilized. In addition, the rotation tool can be inserted into a deeper position by including the tip end-side pin. Furthermore, since the flat surface is formed in the tip end-side pin and the projecting protrusion part is formed on the flat surface, the plastic fluidized material, as friction-stirred along and whirled up by the protrusion part, is pressed by the flat surface. Thus, the friction stirring can be more securely performed around the protrusion part, and concurrently an oxide film of the interface can be securely broken. Accordingly, the joining strength can be enhanced.

Moreover, it is desirable that a temporary joining step of performing temporary joining on the butt part be included before the main joining step. Furthermore, it is desirable that a temporary joining step of performing temporary joining on the overlapped part be included before the main joining step. Such a manufacturing method can prevent a gap in the butt part or the overlapped part during the main joining step.

Moreover, it is desirable that a deburring step of cutting out burr produced by the friction stirring of the rotation tool be included after the main joining step. Such manufacturing methods can neatly finish the front surface of the joint.

### Advantageous Effects of Invention

The heat transfer plate manufacturing method and the friction stir welding method according to the present invention can make the step recessed groove on the front surface of the metal member smaller, reduce the roughness of the front surface of the joint, and enhance the joining strength.

### BRIEF DESCRIPTION OF DRAWINGS

FIG. 1 is a side view showing a rotation tool for main joining to be used for a welding method according to embodiments of the present invention;

FIG. 2 is a magnified cross-sectional view of the rotation tool for main joining;

FIG. 3 is a cross-sectional view showing a first modification of the rotation tool for main joining;

FIG. 4 is a cross-sectional view showing a second modification of the rotation tool for main joining;

FIG. 5 is a cross-sectional view showing a third modification of the rotation tool for main joining;

FIG. 6 is a perspective view showing a heat transfer plate according of a first embodiment of the present invention;

FIG. 7A is a cross-sectional view showing a preparation step of a heat transfer plate manufacturing method according to the first embodiment;

FIG. 7B is a cross-sectional view showing a lid plate inserting step of the heat transfer plate manufacturing method according to the first embodiment;

FIG. 8 is a plan view showing a tab member arranging step of the heat transfer plate manufacturing method according to the first embodiment;

FIG. 9A is a cross-sectional view showing the heat transfer plate manufacturing method according to the first embodiment, and shows a temporary joining method;

FIG. 9B is a cross-sectional view showing the heat transfer plate manufacturing method according to the first embodiment, and shows a main joining method;

FIG. 10A is a conceptual view showing a conventional rotation tool;

FIG. 10B is a conceptual view showing another conventional rotation tool;

FIG. 11A is a cross-sectional view showing a heat transfer plate manufacturing method according to a second embodiment of the present invention, and shows a preparation method;

FIG. 11B is a cross-sectional view showing the heat transfer plate manufacturing method according to the second embodiment of the present invention, and shows a lid plate inserting method;

FIG. 12 is a cross-sectional view showing amain joining step according to the second embodiment;

FIG. 13A is a cross-sectional view showing a heat transfer plate manufacturing method according to a third embodiment of the present invention, and shows a temporary joining method;

FIG. 13B is a cross-sectional view showing the heat transfer plate manufacturing method according to the third embodiment of the present invention, and shows a main joining method;

FIG. 14A is a cross-sectional view showing a heat transfer plate manufacturing method according to a fourth embodiment of the present invention, and shows a temporary joining method;

FIG. 14B is a cross-sectional view showing the heat transfer plate manufacturing method according to the fourth embodiment of the present invention, and shows a main joining method; and

FIG. 15 is a cross-sectional view showing a friction stir welding method according to a fifth embodiment of the present invention.

### DESCRIPTION OF EMBODIMENTS

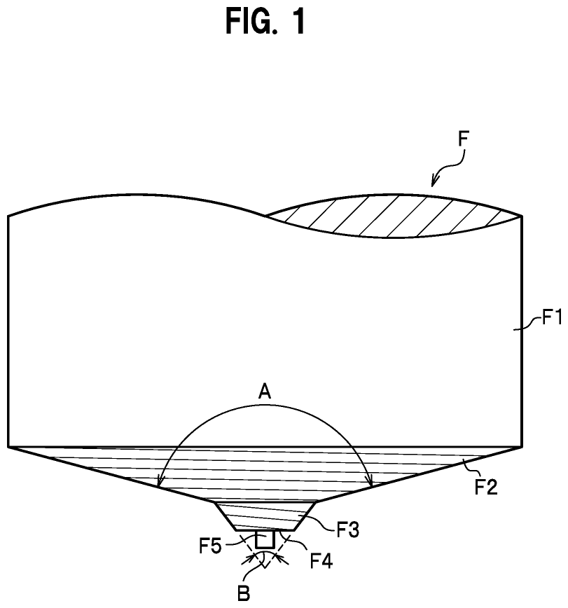

Hereinafter, embodiments of the present invention will be described with reference to the accompanying drawings depending on the necessity. To begin with, descriptions will be provided for a rotation tool for main joining (rotation tool) to be used for a welding method according to embodiments. The rotation tool for main joining is a tool to be used in friction stir welding. As shown in FIG. 1, the rotation tool F for main joining is made, for example, from tool steel, and mainly includes a base shank part F1, a base end-side pin F2 and a tip end-side pin F3. The base shank part F1 is a columnar part designed to be connected to a main shank of a friction stirring apparatus.

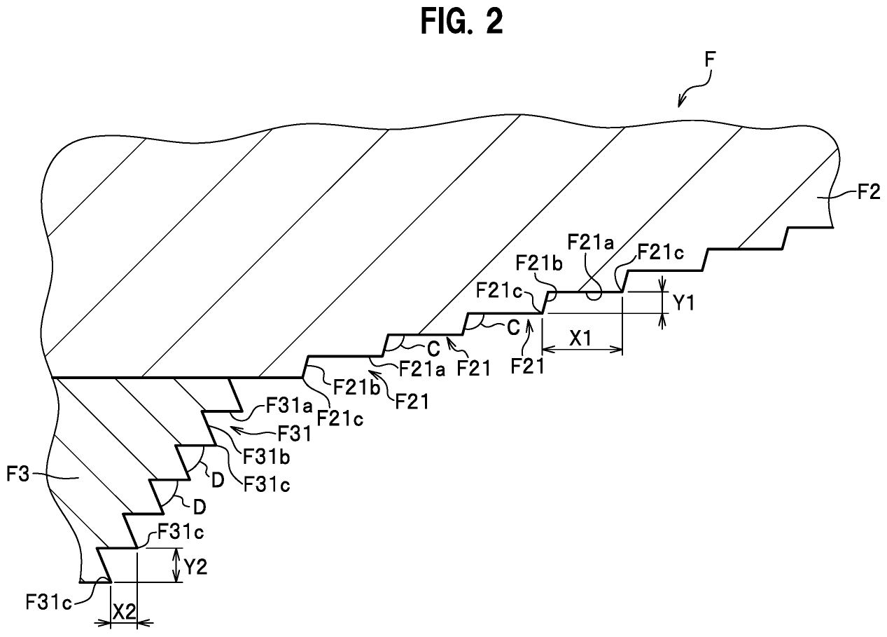

The base end-side pin F2 continues from the base shank part F1, and becomes gradually narrower toward its distal end. The base end-side pin F2 is formed in the shape of a circular truncated cone. A taper angle A of the base end-side pin F2 may be set depending on the necessity, and is set, for example, at not less than 135° or not greater than 160°. The roughness of the front surface of the joint after friction stirring increases when the taper angle A is less than 135° or greater than 160°. The taper angle A is greater than a taper angle B of the tip end-side pin F3, which will be described later. As shown in FIG. 2, a stair-shaped step part F21 is formed on an outer peripheral surface of the base end-side pin F2 while it is covering all the outer peripheral surface in a height direction. The step part F21 is formed in a clockwise or counterclockwise spiral shape. In other words, a plan view of the step part F21 makes it look like a spiral, while a side view of the step part F21 makes it look like a stair. In the embodiments, the step part F21 is set counterclockwise from its base end side to tip end side since the rotation tool F for main joining rotates clockwise.

It should be noted that it is desirable that the step part F21 beset clockwise from its base end side to tip end side while the rotation tool F for main joining rotates counterclockwise. This makes the step part F21 lead plastic fluidized material to its tip end side, and accordingly makes it possible to decrease the amount of metal flowed out of a joined metal member. The step part F21 includes a step bottom surface F21a and a step lateral surface F21b. A distance X1 (a distance in a horizontal direction) between ridges F21c, F21c of each two neighboring portions of the step part F21 is appropriately set depending on a step angle C, and a height Y1 of the step lateral surface F21b, which will be described later.

The height Y1 of the step lateral surface F21b may be set depending on the necessity, and is set, for example, at not less than 0.1 or not greater than 0.4 mm. The roughness of the front surface of the joint increases when the height Y1 is less than 0.1 mm. On the other hand, the roughness of the front surface of the joint tends to increase when the height Y1 is greater than 0.4 mm, and hence the number of substantial steps (the number of portions of the step part F21 to be in contact with the joined metal member) reduces.

The step angle C defined by the step bottom surface F21a and the step lateral surface F21b may be set depending on the necessity, and is set, for example, at not less than 85° or not greater than 120°. In the embodiments, the step bottom surface F21a is parallel with a horizontal plane. The step bottom surface F21a extends in a direction from the rotational axis to outer periphery of the tool, and may incline to the horizontal plane within a range of minus 5° to plus 15° (where minus means a downward inclination to the horizontal plane while plus means an upward inclination to the horizontal plane). The distance X1, the height Y1 of the step lateral surface F21b, the step angle C, and the angle of the step bottom surface F21a to the horizontal plane are appropriately set in a way that, while the friction stirring is being performed, makes it possible to let the plastic fluidized material out to the outside of the step part F21 without allowing the plastic fluidized material to stay in and attach to the inside of the step part F21, and concurrently makes it possible to reduce the roughness of the front surface of the joint by pressing the plastic fluidized material with the step bottom surface F21a.

As shown in FIG. 1, the tip end-side pin F3 is formed continuing from the base end-side pin F2. The tip end-side pin F3 is formed in the shape of a circular truncated cone. A flat surface F4 perpendicular to the rotational axis is formed at the distal end of the tip end-side pin F3. In addition, a protrusion part F5 projecting from the flat surface F4 is formed on the tip end-side pin F3. In other words, a step part is formed with the flat surface F4 and the protrusion part F5. The protrusion part F5 is coaxial with the tip end-side pin F3. The shape of the protrusion part F5 is not limited to a specific one, and is formed in the shape of a cylindrical column in the embodiments. A spiral groove may be formed in a lateral surface of the protrusion part F5.

The taper angle B of the tip end-side pin F3 is less than the taper angle A of the base end-side pin F2. As shown in FIG. 2, a spiral groove F31 is formed on an outer peripheral surface of the tip end-side pin F3. The spiral groove F31 may be formed clockwise or counterclockwise. In the embodiments, the spiral groove F31 is formed counterclockwise from its base end side to tip end side since the rotation tool F for main joining rotates clockwise.

It should be noted that it is desirable that the spiral groove F31 be set clockwise from its base end side to tip end side while the rotation tool F for main joining rotates counterclockwise. This makes the spiral groove F31 lead the plastic fluidized material to its tip end side, and makes it possible to decrease the amount of metal flowed out of the joined metal member. The spiral groove F31 includes a spiral bottom surface F31a and a spiral lateral surface F31b. A length X2 represents a distance (a distance in a horizontal direction) between ridges F31c, F31c of each two neighboring portions of the spiral groove F31. A height Y2 represents a height of the spiral lateral surface F31b. A spiral angle D between the spiral bottom surface F31a and the spiral lateral surface F31b is formed, for example, at not less than 45° or not greater than 90°. The spiral groove F31 has a function of: raising friction heat by contacting the joined metal member; and concurrently leading the plastic fluidized material toward its tip end side.

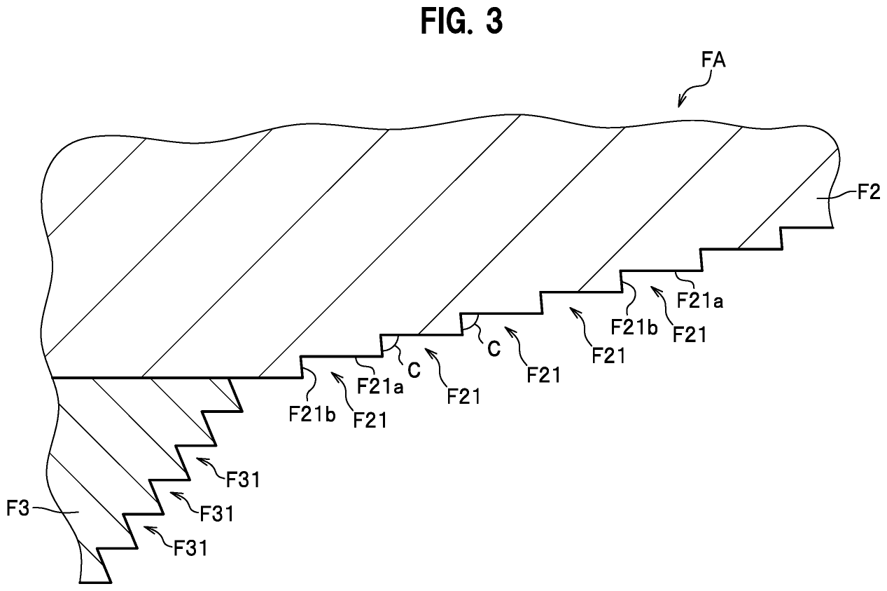

The design of the rotation tool F for main joining can be changed depending on the necessity. FIG. 3 is a side view showing a first modification of the rotation tool according to the present invention. As shown in FIG. 3, in a rotation tool FA for main joining according to the first modification, the step angle C defined by the step bottom surface F21a and the step lateral surface F21b of the step part F21 is set at 85°. The step bottom surface F21a is parallel with the horizontal plane. Like this, the step bottom surface F21a may be parallel with the horizontal plane, and the step angle C may be set at an acute angle within such a range that, while the friction stirring is being performed, makes the plastic fluidized material go out to the outside of the step part F21 without allowing the plastic fluidized material to stay in and attach to the inside of the step part F21.

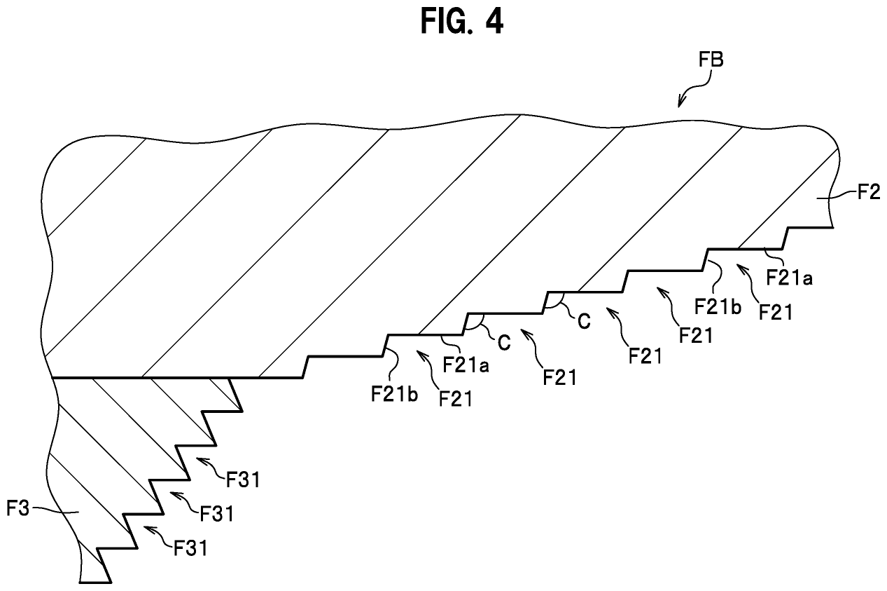

FIG. 4 is a side view showing a second modification of the rotation tool for main joining according to the present invention. As shown in FIG. 4, in a rotation tool FB for main joining according to the second modification, the step angle C of the step part F21 is set at 115°. The step bottom surface F21a is parallel with the horizontal plane. Like this, the step bottom surface F21a may be parallel with the horizontal plane, and the step angle C may be set at an obtuse angle within such a range that makes the step part F21 perform the expected function.

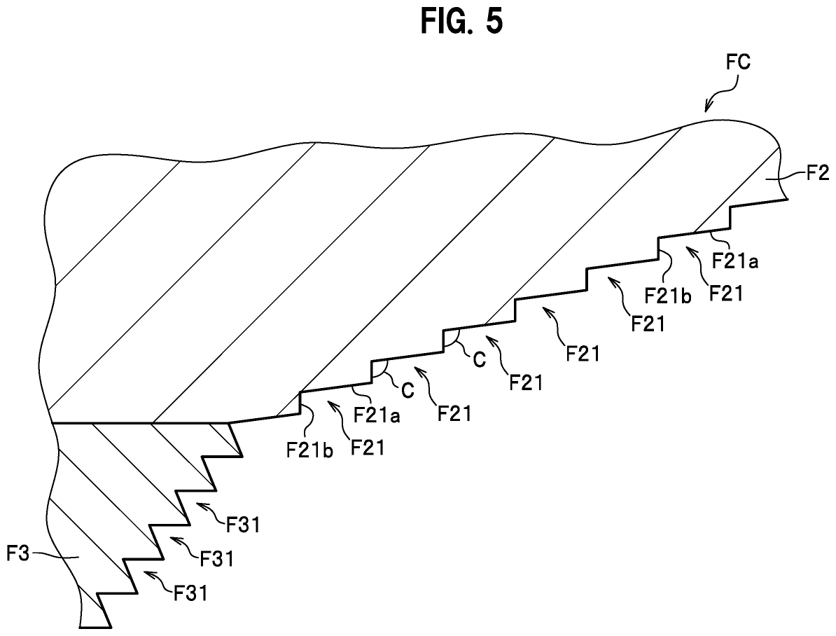

FIG. 5 is a side view showing a third modification of the rotation tool for main joining according to the present invention. As shown in FIG. 5, in a rotation tool FC for main joining according to the third modification, the step bottom surface F21a extends in a direction from the rotational axis to outer periphery of the tool, and inclines upward by 10° to the horizontal plane. The step lateral surface F21b is parallel with the vertical plane. Like this, the step bottom surface F21a may be formed in a way that makes the step bottom surface F21a extend in the direction from the rotational axis to outer periphery of the tool and inclines upward to the horizontal plane, in such a range that enables the step bottom surface F21a to press the plastic fluidized material while the friction stirring is being performed. The first to third modifications of the above-described rotation tool for main joining can bring about the same effects as the following embodiments.

### First Embodiment

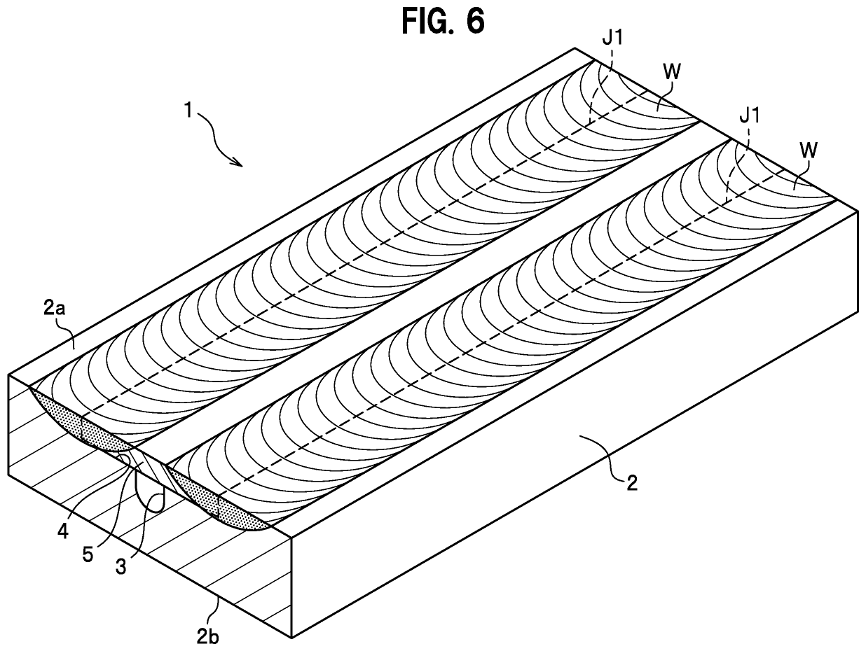

Next, descriptions will be provided for a heat transfer plate according to the first embodiment. In the following descriptions, a “front surface” means an opposite surface of the heat transfer plate to a “back surface.” As shown in FIG. 6, the heat transfer plate 1 according to the first embodiment mainly includes a base member 2 and a lid plate 5. The base member 2 is formed substantially in the shape of a right-angled parallelepiped. A recessed groove 3 and a lid groove 4 are formed in the base member 2. A material of the base member 2 and the lid plate 5 is not limited to a specific one. In the first embodiment, the material is an aluminum alloy. For example, the base member 2 is made of the material having higher hardness than that of the lid plate 5.

The recessed groove 3 penetrates through the center of the base member 2 from one lateral surface to the opposite lateral surface of the base member 2. The recessed groove 3 is provided, in a recessed manner, in a bottom surface 4a of the lid groove 4. A bottom portion of the recessed groove 3 is formed in the shape of an arc. An opening of the recessed groove 3 is open toward a front surface 2a of the base member 2.

The lid groove 4 is formed wider than the recessed groove 3, and continuous to the recessed groove 3 on a front surface 2a-side of the recessed groove 3. In the cross-sectional view, the lid groove 4 is formed in the shape of a rectangle, and is open to the front surface 2a.

The lid plate 5 is a plate-shaped member to be inserted into the lid groove 4. The lid plate 5 is formed in the same shape as a hollow portion of the lid groove 4 in order to be inserted in the lid groove 4 with no space in between.

Butt parts J1, J1 are formed by butting a pair of lateral walls of the lid groove 4 and a pair of lateral surfaces of the lid plate 5. The butt parts J1, J1 are each joined in a depth direction by friction stirring. A space surrounded by lower surfaces, respectively, of the recessed groove 3 and the lid plate 5 in the heat transfer plate 1 serves as a flow path in which the fluid flows.

Next, descriptions will be provided for a heat transfer plate manufacturing method according to the first embodiment.

The heat transfer plate manufacturing method performs a preparation step, a lid plate inserting step, a tab member arranging step, and a temporary joining step, and a main joining step.

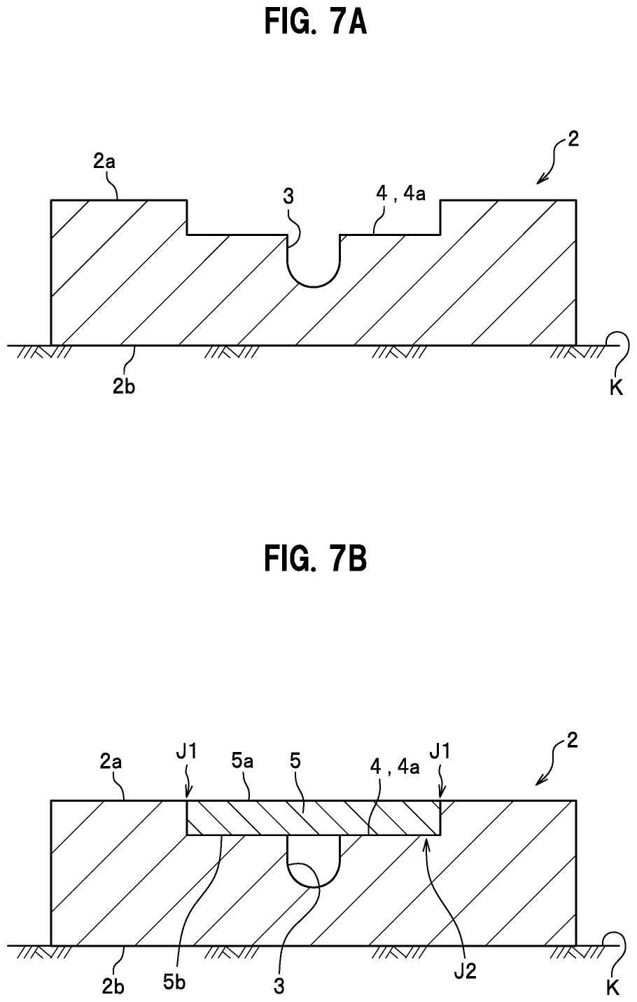

As shown in FIG. 7A, the preparation step is a step of preparing the base member 2. First of all, using a clamp (whose illustration is omitted), the base member 2 is fixed to a stand K. Thereafter, using an endmill or the like, the recessed groove 3 and the lid groove 4 are formed in the base member 2 by a cutting process. Incidentally, the base member 2 in which the recessed groove 3 and the lid groove 4 are formed in advance by die casting or by extrusion molding may be used.

As shown in FIG. 7B, the lid plate inserting step is a step of inserting the lid plate 5 into the lid groove 4. The butt parts J1, J1 are formed by butting the lateral walls of the lid groove 4 and the lateral surfaces of the lid plate 5. A front surface 5a of the lid plate 5 and the front surface 2a are made flush with each other. Furthermore, a butt part J2 is formed by butting the bottom surface 4a of the lid groove 4 and a back surface 5b of the lid plate 5.

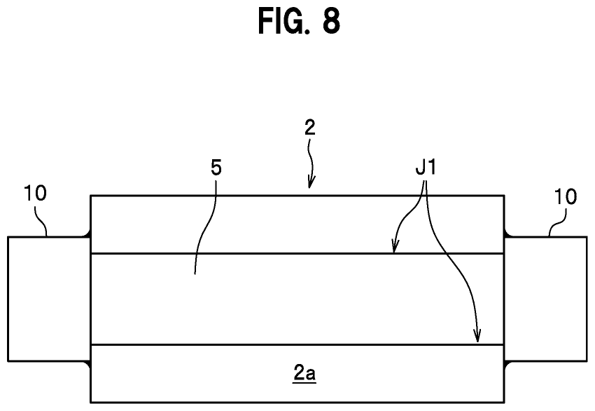

As shown in FIG. 8, the tab member arranging step is a step of arranging tab members 10, 10 on lateral surfaces of the base member 2, respectively. The tab members 10 are members for setting starting and end positions of the friction stirring, which will be described later. The tab members 10 are arranged in surface contact with the mutually-opposite lateral surfaces of the base member 2, and on extension lines of the butt parts J1, J1. In the first embodiment, the tab members 10 are made of an aluminum alloy which is the same as the material of the base member 2. Each tab member 10 is joined to the base member 2 by welding a corner in which the tab member 10 and the base member 2 meet each other.

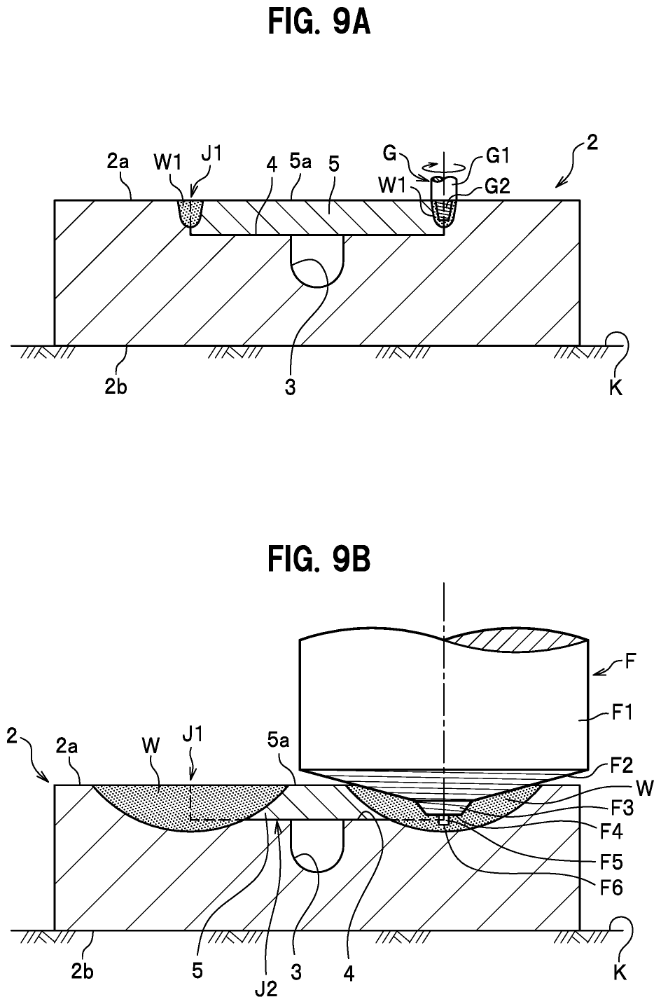

As shown in FIG. 9A, the temporary joining step is a step of preliminarily performing friction stir welding on the butt parts J1, J1 using a rotation tool G for temporary joining. The rotation tool G for temporary joining includes a shoulder part G1 formed in the shape of a cylindrical column, and a stirring pin G2 projecting vertically downward from the shoulder part G1. The starting and end positions of the temporary joining step are not specifically limited as long as they are set on one of the front surfaces, respectively, on the base member 2 and the tab members 10. In the first embodiment, the starting and end positions of the temporary joining step are set on the front surfaces of the tab members 10.

Specifically, the starting position of the temporary joining step is set on the front surface of one tab member 10, and the friction stir welding is performed on one butt part J1 throughout the full length of the butt part J1. A plasticized region W1 is formed on a movement track of the rotation tool G for temporary joining. After moved to the other tab member 10, the rotation tool G for temporary joining is turned on the front surface of the tab member 10, and the friction stir welding is performed on the other butt part J1 throughout the full length of the butt part J1. After moved to the starting tab member 10, the rotation tool G for temporary joining is removed from the tab member 10.

As shown in FIG. 9B, the main joining step is a step of performing friction stir welding on the butt parts J1, J1 using the rotation tool F for main joining. It is desirable that the starting and end positions of the main joining step be set on the front surfaces of the tab members 10. A hole, which is formed when the rotation tool G for temporary joining is removed from the tab member 10, may be used when the rotation tool F for main joining is inserted into the tab member 10. Instead, a pilot hole into which rotation tool F for main joining is inserted may be made in the tab member 10.

In the main joining step, the friction stir welding is performed with the base end-side pin F2 and the tip end-side pin F3 in contact with the base member 2 and the lid plate 5. The friction stir welding is performed with the tip end-side pin F3 of the rotation tool F for main joining, as rotating, inserted into the butt part J1, and with the base member 2 and the lid plate 5 pressed by the outer peripheral surface of the base end-side pin F2. The rotation tool F for main joining is moved along and relative to the butt part J1. The insertion depth of the base end-side pin F2 and the tip end-side pin F3 may be set within a range which enables the outer peripheral surface of the base end-side pin F2 to press the base member 2 and the lid plate 5, depending on the necessity. For example, the insertion depth of the base end-side pin F2 and the tip end-side pin F3 may be set within a range which enables the outer peripheral surface of the base end-side pin F2 to press the base member 2 and the lid plate 5, and the tip end-side pin F3 to reach the lid groove 4. In the first embodiment, the insertion depth is set such that: the flat surface F4 contacts the base member 2 and the lid plate 5; and a tip end surface F6 of the protrusion part F5 contacts only the base member 2. Furthermore, in the first embodiment, the insertion depth is set such that a central portion of the outer peripheral surface of the base end-side pin F2 in the height direction or somewhere around the central portion contacts the base member 2 and the lid plate 5. A plasticized region W is formed on a movement track of the rotation tool F for main joining. After the main joining step, the tab members 10 are removed from the base member 2 by cutting.

It should be noted that a deburring step of cutting out burr produced by the friction stirring may be performed after the main joining step. The deburring step makes it possible to neatly finish the front surfaces of the base member 2 and the lid plate 5.

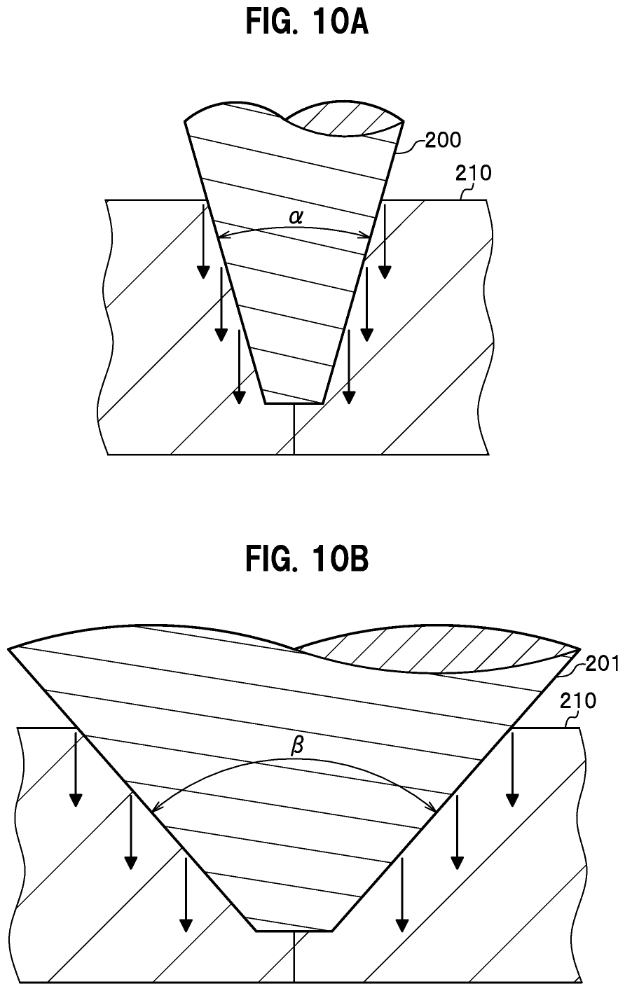

In this respect, for example, a conventional rotation tool 200 is not designed to press a front surface of a joined metal member 210 with a shoulder part, as shown in FIG. 10A. The rotation tool 200, therefore, has a problem of: enlarging the step recessed groove (the recessed groove formed by the front surface of the joined metal member 210 and the front surface of the plasticized region); and increasing the roughness of the front surface of the joint. In addition, the rotation tool 200 has a problem of forming a bulge portion (a portion where the front surface of the joined metal member sticks out more than before the joining) beside the step recessed groove. On the other hand, a rotation tool 201 shown in FIG. 10B has a taper angle β greater than a taper angle α of the rotation tool 200, and is thus capable of pressing the front surface of the joined metal member 210 more than the rotation tool 200 to make both the step recessed groove and the bulge portion smaller. However, the rotation tool 201 makes a downward plastic flow stronger, and kissing bond is accordingly more likely to be formed in a lower portion of the plasticized region.

In contrast to these, the rotation tool F for main joining according to the first embodiment includes: the base end-side pin F2; and the tip end-side pin F3 whose taper angle is smaller than the taper angle A of the base end-side pin F2. This makes the rotation tool F for main joining easy to insert into each butt part J1. Furthermore, since the taper angle B of the tip end-side pin F3 is smaller, the rotation tool F for main joining can be easily inserted into a deep position in the butt part J1. Moreover, since the taper angle B of the tip end-side pin F3 is smaller, the rotation tool F for main joining can inhibit the downward plastic flow more effectively than the rotation tool 201. The rotation tool F for main joining, therefore, can prevent the kissing bond from being formed in the lower portion of the plasticized region W. Meanwhile, since the taper angle A of the base end-side pin F2 is larger, the rotation tool F for main joining can perform the joining more stably than the conventional rotation tools, even if the thickness of the joined metal member and the height position of the joint are changed.

In addition, since the plastic fluidized material can be pressed by the outer peripheral surface of the base end-side pin F2, the step recessed groove formed on the front surface of the joint can be made smaller, and concurrently the bulge portion formed beside the step recessed groove can be eliminated or made smaller. Moreover, since the stair-shaped step part F21 is shallow and the exit is wide, the plastic fluidized material easily goes out of the step part F21 while the plastic fluidized material is pressed by the step bottom surface F21a. Thus, although the plastic fluidized material is pressed by the base end-side pin F2, the plastic fluidized material is less likely to adhere to the outer peripheral surface of the base end-side pin F2. Thereby, the roughness of the front surface of the joint can be reduced, and concurrently the joining quality can be preferably stabilized.

Besides, since the protrusion part F5 is formed on the flat surface F4 on the tip-end side of the tip end-side pin F3, the plastic fluidized material, as friction-stirred along and whirled up by the protrusion part F5, is pressed by the flat surface F4. Thus, the friction stirring can be more securely performed around the protrusion part F5 (the butt part J2), and concurrently an oxide film of the butt part J2 can be securely broken. Accordingly, the joining strength of the butt part J2 can be enhanced.

In addition, in the main joining step, since the friction stirring is formed throughout the full length of the depth of each butt part J1, the water and air tightness of the heat transfer plate 1 can be accordingly enhanced.

Furthermore, the temporary joining step makes it possible to prevent the gap between the base member 2 and the lid plate 5 during the main joining step. Moreover, the temporary joining step and the main joining step are performed by moving the rotation tool G for temporary joining and the rotation tool F for main joining with one stroke without detaching the rotation tools from the base member 2 in the middle of the friction stirring. This makes it possible to reduce labor and time required.

It should be noted that in the temporary joining step, the friction stirring may be discontinuously performed so as for the rotation tool G for temporary joining to intermittently form the plasticized region W1. In addition, in the temporary joining step, the welding may be performed on the butt parts J1, J1. Furthermore, the tab members 10 are temporarily joined to the base member 2 using the rotation tool G for temporary joining.

### Second Embodiment

Next, descriptions will be provided for a second embodiment of the present invention. A heat transfer plate according to the second embodiment includes a heat medium tube 6. This makes the second embodiment different from the first embodiment. The heat medium tube 6 is a member in which a fluid flows.

A heat transfer plate manufacturing method according to the second embodiment performs a preparation step, a heat medium tube inserting step, a lid plate inserting step, a temporary joining step, and a main joining step.

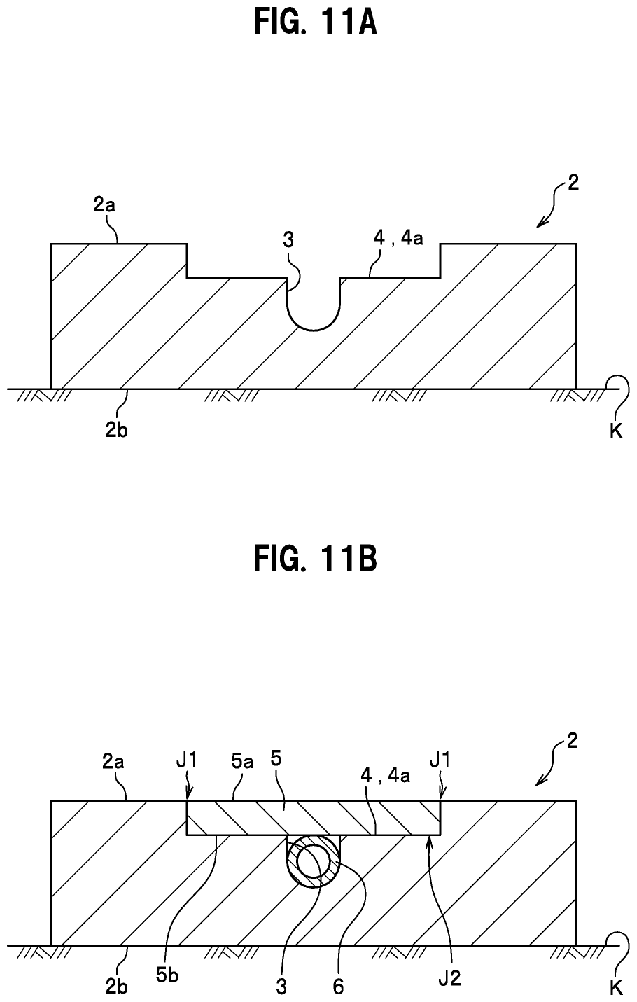

As shown in FIG. 11A, the preparation step is the step of preparing the base member 2.

As shown in FIG. 11B, the heat medium tube inserting step is a step of inserting the heat medium tube 6 into the recessed groove 3. Sizes and the like of the recessed groove 3 and the heat medium tube 6 may be set depending on the necessity. In the second embodiment, the outer diameter of the heat medium tube 6, and the width and depth of the recessed groove 3 are substantially equal to one another.

The lid plate inserting step is a step of inserting the lid plate 5 into the lid groove 4. The butt parts J1, J1 are formed by butting the lateral walls of the lid groove 4 and the lateral surfaces of the lid plate 5. Furthermore, the butt part J2 is formed by butting the bottom surface 4a of the lid groove 4 and the back surface 5b of the lid plate 5. Once the lid plate 5 is inserted into the lid groove 4, the lid plate 5 comes into contact with the heat medium tube 6, and the front surface 5a of the lid plate 5 becomes flush with the front surface 2a of the base member 2.

The temporary joining step is a step of preliminarily performing joining on the butt parts J1, J1. The temporary joining step is performed in the same way as in the first embodiment.

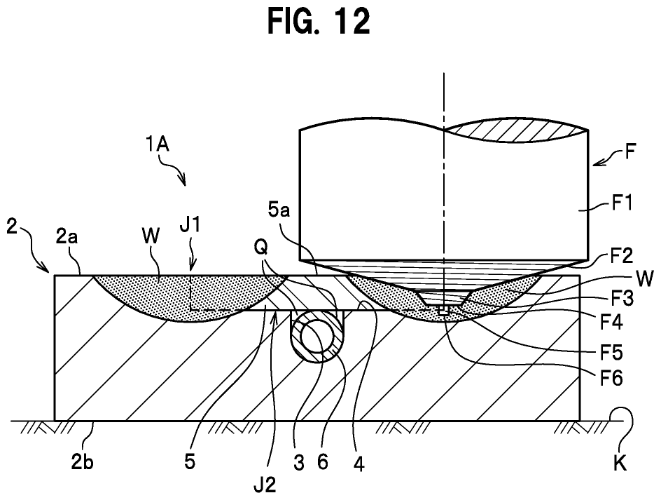

As shown in FIG. 12, the main joining step is a step of performing friction stir welding on the butt parts J1, J1 using the rotation tool F for main joining. The main joining step is performed in the same way as in the first embodiment. The plasticized regions W, W are formed on the movement track of the rotation tool F for main joining. Each plasticized regions W is formed throughout the full length of each of the butt parts J1, J1 in the depth direction.

The heat transfer plate manufacturing method according to the second embodiment can bring about the substantially same effects as that according to the first embodiment. In addition, a heat transfer plate 1A including the heat medium tube 6 can be easily manufactured.

In addition, for example, the shapes of the recessed groove 3, the lid groove 4, the lid plate 5 and the heat medium tube 6 according to the first and second embodiments are shown as examples, and may be different from the examples. Furthermore, after the main joining step, in a case where a step is produced between the front surface 2a of the base member 2 and the plasticized region W, overlay welding may be performed in order to fill the step. Otherwise, a metal member may be arranged on the front surface of the plasticized region W to join the metal member and the base member 2 by friction stirring using the rotation tool F for main joining.

Besides, although the second embodiment has been shown as one which is provided with the lid groove 4, the second embodiment may be one which is provided with no lid groove 4 and in which the lid plate 5 is directly inserted into the recessed groove 3.

Moreover, in a case where as shown in FIG. 12, a gap part Q is formed around the heat medium tube 6, the gap part Q may be filled in the main joining step. In the lid plate inserting step, once the lid plate 5 is inserted into the lid groove 4, the gap part Q is formed by the recessed groove 3, the lower surface of the lid plate 5, and the heat medium tube 6. The positions of the butt parts J1, J1 are set close to the heat medium tube 6, and in the main joining step, the plastic fluidized material formed by the rotation tool F for main joining is made to flow in the gap part Q. Thereby, the gap part Q around the heat medium tube 6 is filled with the metal. This makes it possible to enhance the water and air tightness more.

### Third Embodiment

Next, descriptions will be provided for a third embodiment of the present invention. A heat transfer plate manufacturing method according to the third embodiment forms no lid groove 4 in the base member 2, and places the lid plate 5 on the front surface 2a of the base member 2. This makes the third embodiment different from the first embodiment.

The heat transfer plate manufacturing method according to the third embodiment performs a preparation step, a recessed groove closing step, a temporary joining step, and a main joining step.

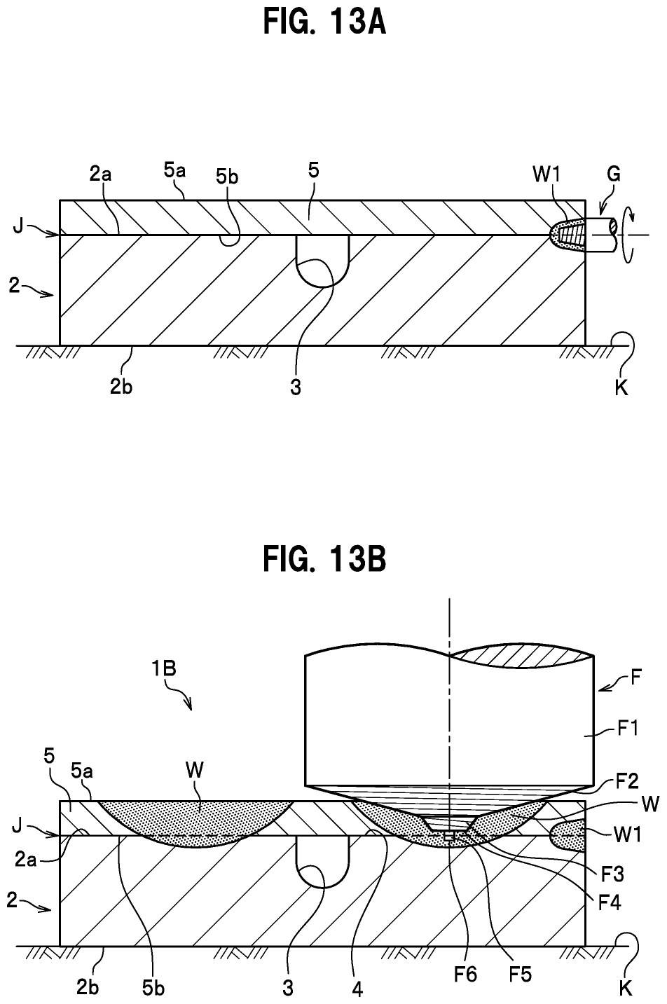

As shown in FIG. 13A, the preparation step is a step of preparing the base member 2. The recessed groove 3 is formed on the front surface 2a of the base member 2.

The recessed groove closing step (closing step) is a step of covering an upper portion of the recessed groove 3 by placing the lid plate 5 on the front surface 2a of the base member 2. In the recessed groove closing step, an overlapped part J is formed by overlapping the front surface 2a of the base member 2 and the back surface 5b of the lid plate 5.

The temporary joining step is a step of preliminarily performing joining on the overlapped part J. In the third embodiment, in the temporary joining step, the rotation tool G for temporary joining is inserting from lateral surfaces of the base member 2 and the lid plate 5, and friction stir welding is performed on the overlapped part J. After the temporary joining step, the plasticized region W1 is formed in the lateral surfaces of the base member 2 and the lid plate 5.

As shown in FIG. 13B, the main joining step is a step of performing friction stir welding on the overlapped part J using the rotation tool F for main joining. The friction stir welding is performed on the overlapped part J by: inserting the tip end-side pin F3 of the rotation tool F for main joining, as rotating, from the front surface 5a of the lid plate 5; and relatively moving the rotation tool F for main joining along the longitudinal direction of the recessed groove 3. The movement route of the rotation tool F for main joining is set in a way that prevents the plastic fluidized material from flowing into the recessed groove 3.

In the main joining step, the friction stir welding is performed while pressing the front surface 5a of the lid plate 5 using the outer peripheral surface of the base end-side pin F2. In the main joining step, the friction stir welding is performed with the base end-side pin F2 in contact with the lid plate 5, and with the tip end-side pin F3 in contact with both the base member 2 and the lid plate 5. The insertion depth of the base end-side pin F2 and the tip end-side pin F3 may be set within a range which enables the outer peripheral surface of the base end-side pin F2 to press the front surface 5a of the lid plate 5, depending on the necessity. In the third embodiment, the setting is performed with the central portion of the outer peripheral surface of the base end-side pin F2 in the height direction or somewhere around the central portion in contact with the front surface 5a of the lid plate 5, and with the tip end-side pin F3 in contact with the base member 2. More specifically, in the main joining step, the friction stirring is performed with the flat surface F4 of the tip end-side pin F3 in contact with only the lid plate 5, and with the tip end surface F6 of the protrusion part F5 in contact with only the base member 2. In other words, in the main joining step, the insertion depth of the base end-side pin F2 and the tip end-side pin F3 is set such that the lateral surface of the protrusion part F5 is located in the overlapped part J. Thus, the third embodiment can bring about the substantially same effects as the first embodiment.

The heat transfer plate manufacturing method according to the third embodiment can easily manufacture a heat transfer plate 1B, although the heat transfer plate manufacturing method is that in which: the base member 2 is provided with no lid groove 4; and the lid plate 5 with a large plate thickness is placed on the front surface 2a of the base member 2. Furthermore, the temporary joining step makes it possible to prevent the gap between the base member 2 and the lid plate 5 during the main joining step.

It should be noted that in the temporary joining step, the friction stirring may be discontinuously performed so as for the rotation tool G for temporary joining to intermittently form the plasticized region W1. In addition, in the temporary joining step, the welding may be performed on the overlapped part J. Furthermore, the third embodiment may perform the temporary joining step and the main joining step using the tab members, like in the first embodiment.

In addition, in the third embodiment, the insertion depth is set such that the distal end of the tip end-side pin F3 (the tip end surface F6 of the protrusion part F5) is pressed in up to the position where the distal end thereof reaches the base member 2. However, the insertion depth may be set such that the distal end does not reach the base member 2, that is to say, such that both the base end-side pin F2 and the tip end-side pin F3 come into contact with only the lid plate 5. In this case, friction heat produced by the contact of the base end-side pin F2 and the tip end-side pin F3 with the lid plate 5 plastically fluidizes the overlapped part J. Thus, the joining is performed on the overlapped part J.

Furthermore, although in the third embodiment, the rotation tool F for main joining is inserted from the front surface 5a of the lid plate 5, the rotation tool F for main joining may be inserted from the back surface 2b of the base member 2 to perform the friction stirring on the overlapped part J. In this case, the rotation tool F for main joining is inserted from the back surface 2b of the base member 2; the flat surface F4 is put into contact with only the base member 2; and the tip end surface F6 of the protrusion part F5 is put into contact with only the lid plate 5. Moreover, in this case, the insertion depth is set such that the outer peripheral surface of the base end-side pin F2 comes into the back surface 2b of the base member 2.

### Fourth Embodiment

Next, descriptions will be provided for a fourth embodiment of the present invention. A heat transfer plate manufacturing method according to the fourth embodiment forms a recessed part 20 including a large recess. This makes the fourth embodiment different from the third embodiment.

The heat transfer plate manufacturing method according to the fourth embodiment performs a preparation step, a recessed part closing step, a temporary joining step, and amain joining step.

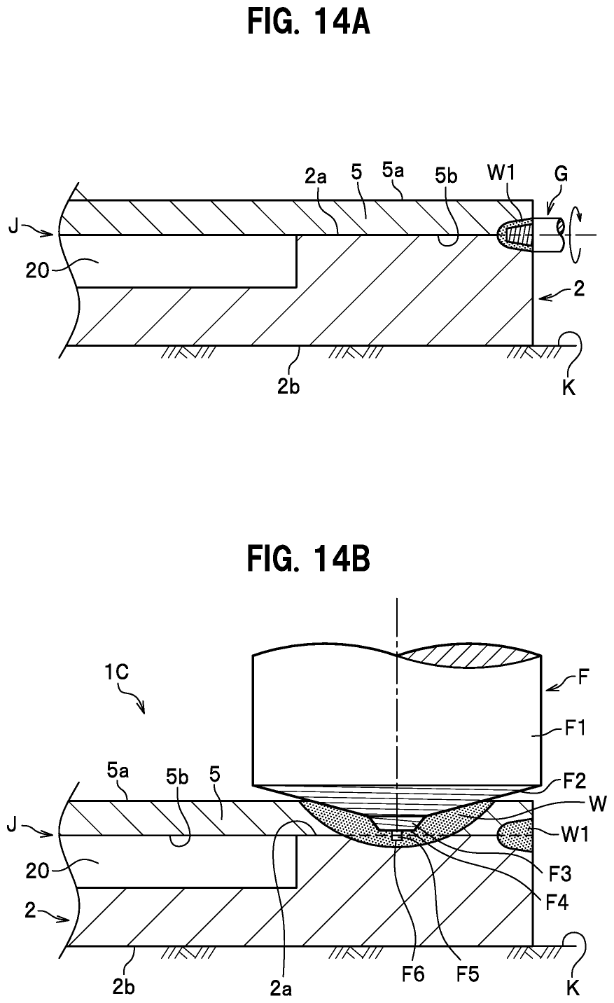

As shown in FIG. 14A, the preparation step is a step of preparing the base member 2. The recessed part 20 is formed on the front surface 2a of the base member 2. The recessed part 20 is a recess which is sufficiently wider than the recessed groove 3.

The recessed part closing step (closing step) is a step of covering an upper portion of the recessed part 20 by placing the lid plate 5 on the front surface 2a of the base member 2. In the recessed part closing step, an overlapped part J is formed by overlapping the front surface 2a of the base member 2 and the back surface 5b of the lid plate 5. As shown in FIG. 14B, the temporary joining step and the main joining step are the same as those according to the third embodiment, and detailed descriptions for them will be omitted. The heat transfer plate manufacturing method manufactures a heat transfer plate 1C.

The heat transfer plate manufacturing method according to the fourth embodiment can bring about the substantially same effects as that according to the third embodiment. In addition, the fourth embodiment is capable of easily manufacturing the heat transfer plate 1C, although: the heat transfer plate 1C includes the recessed part 20 which is larger than the recessed groove 3; and the lid plate 5 with a large plate thickness is placed thereon.

Furthermore, although in the fourth embodiment, the rotation tool F for main joining is inserted from the front surface 5a of the lid plate 5, the rotation tool F for main joining may be inserted from the back surface 2b of the base member 2 to perform the friction stirring on the overlapped part J. In this case, the rotation tool F for main joining is inserted from the back surface 2b of the base member 2; the flat surface F4 is put into contact with only the base member 2; and the tip end surface F6 of the protrusion part F5 is put into contact with only the lid plate 5. Moreover, in this case, the insertion depth is set such that the outer peripheral surface of the base end-side pin F2 is put into contact with the back surface 2b of the base member 2.

### Fifth Embodiment

Next, descriptions will be provided for a friction stir welding method according to a fifth embodiment of the present invention. In the fifth embodiment, metal members each including neither the recessed groove 3 nor the recessed part 20 are welded together. This makes the fifth embodiment different from the other embodiments.

The friction stir welding method according to the fifth embodiment performs a preparation step, an overlapping step (an overlapped part forming step), a temporary joining step, and a main joining step.

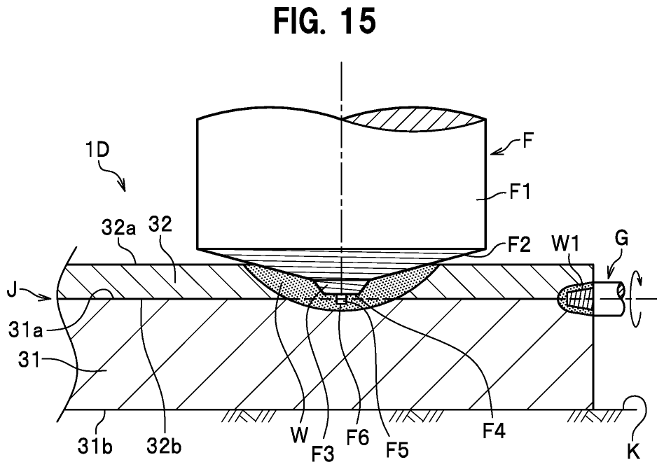

As shown in FIG. 15, the preparation step is a step of preparing the metal members 31, 32. The metal members 31, 32 are plate-shaped metal members. The types of materials of the metal members 31, 32 may be selected from friction-stirrable metals depending on the necessity. For example, the type of material of the metal member 32 into which the rotation tool F for main joining is inserted may have lower hardness than that of the metal member 31.

The overlapping step (the overlapped part forming step) is a step of overlapping the metal members 31, 32. The overlapping step forms an overlapped part J by overlapping a front surface 31a of the metal member 31 and a back surface 32b of the metal member 32.

The temporary joining step is a step of preliminarily performing joining on the overlapped part J. In the fifth embodiment, in the temporary joining step, the rotation tool G for temporary joining is inserted from lateral surfaces of the metal members 31, 32; and friction stir welding is performed on the overlapped part J. After the temporary joining step, a plasticized region W1 is formed in the lateral surfaces of the metal members 31, 32.

The main joining step is a step of performing friction stir welding on the overlapped part J using the rotation tool F for main joining. In the fifth embodiment, the rotation tool F for main joining is vertically inserted from the front surface 32a of the metal member 32, and is set such the distal end of the tip end-side pin F3 enters the metal member 31. The main joining step is a step of performing friction stir welding on the overlapped part J using the rotation tool F for main joining. The tip end-side pin F3 of the rotation tool F for main joining, as rotating, is inserted from the front surface 32a of the metal member 32, the friction stir welding is performed on the overlapped part J by moving the rotation tool F for main joining relative to the overlapped part J. In the main joining step, the friction stir welding is performed with the front surface 32a of the metal member 32 pressed by the outer peripheral surface of the base end-side pin F2 (with the outer peripheral surface thereof in contact with the front surface 32a). More specifically, in the main joining step, the friction stirring is performed with the flat surface F4 of the tip end-side pin F3 in contact with only the metal member 32, and with the tip end surface F6 of the protrusion part F5 in contact with only the metal member 31. In other words, in the main joining step, the insertion depth of the base end-side pin F2 and the tip end-side pin F3 is set such that the lateral surface of the protrusion part F5 is located in the overlapped part J. Thereby, a composite plate 1D is formed.

The friction stir welding method according to the fifth embodiment easily manufactures the composite plate 1D including no flow path in its inside. The friction stir welding method according to the fifth embodiment can bring about the substantially same effects as that according to the third embodiment.

In addition, the temporary joining step makes it possible to prevent a gap between the metal members 31, 32 during the main joining step.

It should be noted that in the temporary joining step, the friction stirring may be discontinuously performed so as for the rotation tool G for temporary joining to intermittently form the plasticized region W1. In addition, in the temporary joining step, welding may be performed on the overlapped part J. Furthermore, the temporary joining step and the main joining step may be performed using the tab members, like in the first embodiment.

### REFERENCE SIGNS LIST

1: heat transfer plate
2: base member
3: recessed groove
4: lid groove
5: lid plate
6: heat medium tube
10: tab member
20: recessed part
31: metal member
32: metal member
F: rotation tool for main joining (rotation tool)
F2: base end-side pin
F3: tip end-side pin
F4: flat surface
F5: protrusion part
G: rotation tool for temporary joining
J1: butt part
J: overlapped part
W: plasticized region

1. A heat transfer plate manufacturing method comprising:
a lid plate inserting step of inserting a lid plate into a lid groove which is formed around a recessed groove opening at a front surface of a base member; and
a main joining step of performing friction stirring by moving a rotation tool including a base end-side pin and a tip end-side pin along and relative to a butt part between a lateral wall of the lid groove and a lateral surface of the lid plate, wherein
a taper angle of the base end-side pin is greater than that of the tip end-side pin,
a stair-shaped step part is formed on an outer peripheral surface of the base end-side pin,
a flat surface perpendicular to a rotational axis of the rotation tool, and a protrusion part projecting from the flat surface are formed on a tip-end side of the tip end-side pin, and
in the main joining step, the tip end-side pin of the rotation tool, as rotating, is inserted into the butt part, and friction stirring is performed with the outer peripheral surface of the base end-side pin in contact with the front surfaces of the base member and the lid plate, with the base end-side pin and the flat surface in contact with the base member and the lid plate, and with a tip end surface of the protrusion part in contact with only the base member.

2. The heat transfer plate manufacturing method according to claim 1, further comprising:
a heat medium tube inserting step of inserting a heat medium tube into the recessed groove formed in the bottom surface of the lid groove opening at the front surface of the base member.

3. The heat transfer plate manufacturing method according to claim 1, comprising a temporary joining step of performing temporarily joining on the butt part before the main joining step.

4. A heat transfer plate manufacturing method comprising:
a closing step of overlapping a lid plate on a front surface of a base member such that the lid plate covers a recessed groove or a recessed part opening at the front surface of the base member; and
a main joining step of inserting a rotation tool including a base end-side pin and a tip end-side pin from a front surface of the lid plate, and moving the rotation tool along and relative to an overlapped part formed by overlapping the front surface of the base member and a back surface of the lid plate, wherein
a taper angle of the base end-side pin is greater than that of the tip end-side pin,
a stair-shaped step part is formed on an outer peripheral surface of the base end-side pin,
a flat surface perpendicular to a rotational axis of the rotation tool, and a protrusion part projecting from the flat surface are formed on a tip-end side of the tip end-side pin, and
in the main joining step, friction stirring is performed on the overlapped part with the outer peripheral surface of the base end-side pin in contact with the front surface of the lid plate, with the base end-side pin and the flat surface in contact with only the lid plate, and with a tip end surface of the protrusion part in contact with only the base member.

5. (canceled)

6. The heat transfer plate manufacturing method according to claim 4, comprising a temporary joining step of performing temporary joining on the overlapped part before the main joining step.

7. The heat transfer plate manufacturing method according to claim 1, comprising a deburring step of cutting out burr produced by the friction stirring of the rotation tool after the main joining step.

8. A friction stir welding method for joining two metal members together using a rotation tool including a base end-side pin and a tip end-side pin, wherein
a taper angle of the base end-side pin is greater than that of the tip end-side pin,
a stair-shaped step part is formed on an outer peripheral surface of the base end-side pin,
a flat surface perpendicular to a rotational axis of the rotation tool, and a protrusion part projecting from the flat surface are formed on a tip-end side of the tip end-side pin,
the friction stir welding method comprises
an overlapped part forming step of forming an overlapped part by overlapping a front surface of one metal member and a back surface of the other metal member, and
a main joining step of inserting the tip end-side pin of the rotation tool, as rotating, from a front surface of the other metal member, and performing friction stirring on the overlapped part with the outer peripheral surface of the base end-side pin in contact with the front surface of the other metal member, with the base end-side pin and the flat surface in contact with only the other metal member, and with a tip end surface of the protrusion part in contact with only the one metal member, and
hardness of the other metal member is set lower than that of the one metal member.

9. The friction stir welding method according to claim 8, comprising a temporary joining step of performing temporary joining on the overlapped part before the main joining step.

10. The friction stir welding method according to claim 8, comprising a deburring step of cutting out burr produced by the friction stirring of the rotation tool after the main joining step.

11. The heat transfer plate manufacturing method according to claim 4, comprising a deburring step of cutting out burr produced by the friction stirring of the rotation tool after the main joining step.
